(19) United States
(12) Patent Application Publication
(10) Pub. No.: US 2023/0031372 A1
(43) Pub. Date: Feb. 2, 2023

(54) SILICA SAND AGGLOMERATES FOR SILICON METAL PRODUCTION AND METHOD OF FORMING THE SAME

(71) Applicants: HEEJA LEE, Yongin-si (KR); SANGBOK SUNG, Yongin-si (KR); HAKSOO SUNG, Yongin-si (KR); YOOHWA SUNG, Yongin-si (KR)

(72) Inventor: HEEJA LEE, Yongin-si (KR)

(21) Appl. No.: 17/443,686

(22) Filed: Jul. 27, 2021

(51) Int. Cl. C01B 33/025; C01B 33/12

(52) U.S. Cl. CPC C01B 33/025; C01B 33/12; C01P 2004/50; C01P 2004/32; C01P 2004/60

(57) ABSTRACT

Silica sand agglomerates for silicon metal production according to the present invention may be formed in the form of lumps by mixing clay, a liquid adhesive, and silica sand having a particle size in a certain range, and thus be maintained in shape during reduction in a high-temperature carbothermal reduction furnace to facilitate heat transfer and gas circulation.

### BACKGROUND OF THE INVENTION

### 1. Field of the Invention

The present invention relates to a technology for producing silicon metal by using silica sand and, more particularly, to silica sand agglomerates pre-processed to be inserted into a high-temperature reduction furnace in order to produce silicon metal by heating silica sand in the reduction furnace, and a method of forming the agglomerates.

### 2. Description of the Related Art

Silicon is one of the most abundant elements in nature. Silicon is a metalloid element between metal and nonmetal. In nature, silicon normally exists in the form of silicon dioxide or silicate. Silicon was first obtained in 1811 by heating silicon dioxide. Silicon (Si) was discovered as an element by Berzelius in 1824. Crystalline silicon with a gray metallic luster was first prepared by Deweili in 1855.

High-purity silicon was prepared by D. W. Lyon based on SiCd₄+2Zn=2ZnCl₂+Si. The periodic table of elements was created by Dmitri Ivanovich Mendeleev in 1869, and silicon was defined with atomic number 14 and group IV A. Carbothermal reduction of silicon for a mass production in the modern industry was discovered in the early 20th century and has been used for less than 100 years. Silicon produced through carbothermal reduction by using silica stone and a carbon reductant as raw materials has 99% or higher purity and thus is named as ‘silicon 99’, and is also called silicon metal in western countries and crystalline silicon in Russia.

Monocrystalline silicon (with 99.99% purity) may be produced by performing a series of refining processes on high-purity silicon metal. Monocrystalline silicon is used in the electronics industry as a major raw material for semiconductors. Currently, high-purity silicon 99 has a wide range of use, and the demand for silicon 99 is gradually increasing in domestic and overseas markets. Due to the advancement of high technology and the development of global economy, the use of silicon is gradually expanding and the demand for silicon is gradually increasing.

Before the 1960s of the 20th century, France, the United States, Japan, Italy, and the former Soviet Union have built single-phase and three-phase electric furnaces of thousands of kilowatts in succession, and refined silicon metal in the furnaces by using carbothermal reduction.

A process of reducing silicon metal based on carbothermal reduction is represented by the following chemical equation: SiO₂+2C→Si+2CO. Such reduction is endothermic reaction and occurs in a high-temperature reduction furnace. The above-described carbothermal reduction method is disclosed in Korean Patent Publication No. 10-2010-0043092 (published on Apr. 27, 2010).

Silica stone has been used as a raw material for silicon metal as disclosed in Korean Patent Publication No. 2010-0043092. In general, silica stone is finely crushed, mixed with a necessary material such as activated carbon, and heated to high temperature in an electric furnace including a carbon rod, thereby causing reduction. However, as a raw material for silicon metal, silica stone (i.e., quartz) widespread on earth has been mined in large quantities since the 1960s and thus is no longer easily available.

Therefore, related industries are seeking a substitute for silica stone as a raw material for silicon metal. Silica sand contains almost the same components as silica stone and thus may be a good substitute for silica stone. Although silica stone has high strength and thus is not easily broken during a carbothermal reduction process, silica sand does not have a form of lumps and thus may not be directly inserted into a carbothermal reduction furnace. When lumps of silica sand inserted into the carbothermal reduction furnace are broken, reduction may not properly occur due to poor heat transfer or poor gas circulation. Therefore, the lumps of silica sand inserted into the carbothermal reduction furnace need to have sufficient strength.

However, silica sand has a form of particles and may not be easily formed into lumps like silica stone. Silica sand needs to agglomerate together into lumps like silica stone to cause reduction when inserted into a reduction furnace. However, silica sand agglomerates like silica stone are not currently developed.

### SUMMARY OF THE INVENTION

The present invention provides silica sand agglomerates for silicon metal production as a substitute for silica stone.

According to an embodiment of the present invention, silica sand agglomerates for silicon metal production include 3 wt % to 6 wt % of clay, 4 wt % to 9 wt % of a liquid adhesive, and a remaining content of silica sand having a particle size of 0.03 mm to 0.7 mm.

According to another embodiment of the present invention, silica sand agglomerates for silicon metal production include 12 wt % to 18 wt % of clay, 9 wt % to 15 wt % of a liquid adhesive, and a remaining content of silica sand having a particle size of 0.8 mm to 2.3 mm.

According to another embodiment of the present invention, silica sand agglomerates for silicon metal production include 12 wt % to 18 wt % of clay, 9 wt % to 15 wt % of a liquid adhesive, and a remaining content of silica sand having a particle size of 0.8 mm to 2.3 mm.

The liquid adhesive may be obtained by mixing starch powder and water.

According to another embodiment of the present invention, a method of forming the silica sand agglomerates includes a mixing step for mixing clay, a liquid adhesive, and silica sand, a pressing step for pressing the mixture obtained in the mixing step, to reduce pores and increase a density, a forming step for forming the mixture pressed in the pressing step, into certain-sized agglomerates, and a drying step for drying the agglomerates formed in the forming step.

The agglomerates formed in the forming step may have a spherical, cylindrical, oval briquette, or pebble shape.

The agglomerates dried in the drying step may have an apparent density of 85% to 98%.

The drying step may employ heat drying, blow drying, or natural drying.

### BRIEF DESCRIPTION OF THE DRAWINGS

The above and other features and advantages of the present invention will become more apparent by describing in detail embodiments thereof with reference to the attached drawings in which:

FIG. 1 is a table showing components of silica sand agglomerates for silicon metal production, according to the present invention;

FIG. 2 is a flowchart of a method of forming the silica sand agglomerates for silicon metal production, according to the present invention;

FIG. 3 is a photographic image of the silica sand agglomerate for silicon metal production, according to the present invention;

FIG. 4 is a photographic image showing that the silica sand agglomerates for silicon metal production shown in FIG. 3 are loaded in a carbothermal reduction furnace; and

FIG. 5 is a photographic image showing that the silica sand agglomerates for silicon metal production shown in FIG. 4 are heated to 130° C. and then cooled to room temperature.

### DETAILED DESCRIPTION OF THE INVENTION

Hereinafter, the present invention will be described in detail by explaining embodiments of the invention with reference to the attached drawings.

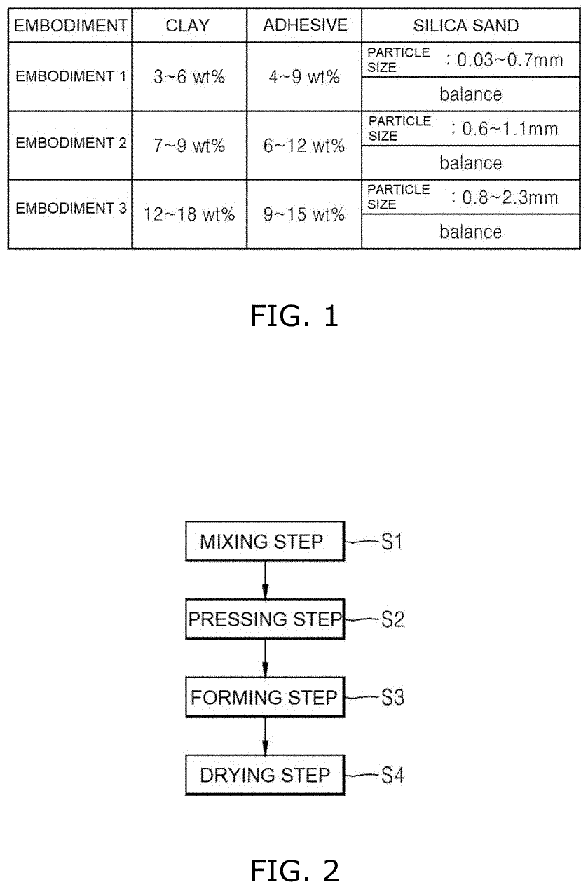

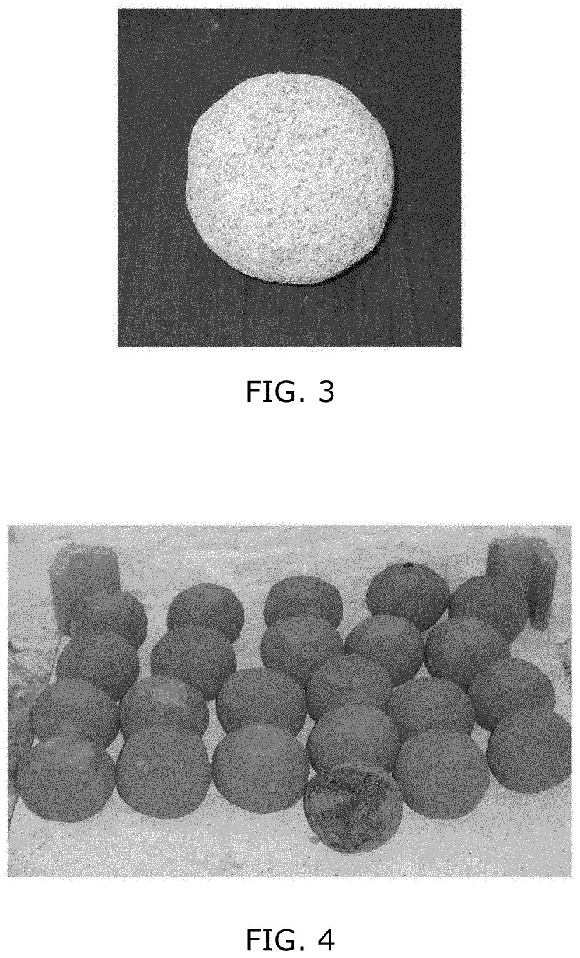

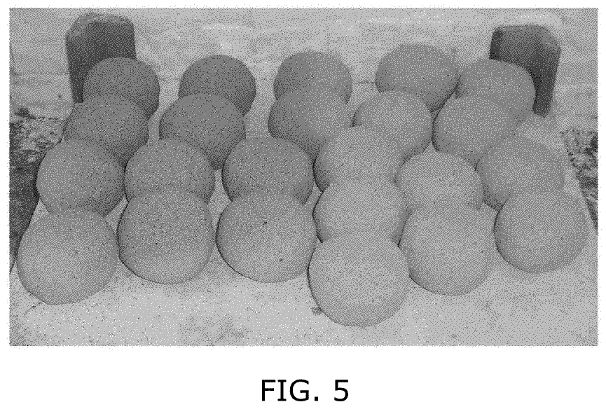

FIG. 1 is a table showing components of silica sand agglomerates for silicon metal production, according to the present invention. FIG. 2 is a flowchart of a method of forming the silica sand agglomerates for silicon metal production, according to the present invention. FIG. 3 is a photographic image of the silica sand agglomerate for silicon metal production, according to the present invention. FIG. 4 is a photographic image showing that the silica sand agglomerates for silicon metal production shown in FIG. 3 are loaded in a carbothermal reduction furnace. FIG. 5 is a photographic image showing that the silica sand agglomerates for silicon metal production shown in FIG. 4 are heated to 1300° C. and then cooled to room temperature.

### Embodiment 1

According to Embodiment 1 of the present invention, silica sand agglomerates for silicon metal production include 3 wt % to 6 wt % of clay, 4 wt % to 9 wt % of a liquid adhesive, and the remaining content of silica sand having a particle size of 0.03 mm to 0.7 mm.

The clay is mixed to maintain binding between the silica sand particles in a reduction process of the agglomerates inserted into a carbothermal reduction furnace. The weight of the mixed clay varies depending on the size of the silica sand particles. The clay may employ, for example, kaolin or loess used to manufacture ceramics. In the current embodiment, when the content of the clay is less than 3 wt %, the agglomerates may be broken into powder at an early stage due to excessively low binding force between the silica sand particles during reduction of the agglomerates in the carbothermal reduction furnace and thus silicon metal may not be properly obtained due to poor heat transfer around the silica sand particles and poor circulation of a reduction gas. When the content of the clay is greater than 6 wt %, although the agglomerates are maintained in sufficient strength during reduction in the carbothermal reduction furnace, the amount of silicon metal in the agglomerates may be reduced due to an excessively large amount of the clay and thus only a small amount of silicon metal may be produced. In the present invention, the clay refers to a material containing a clay mineral such as a kaolin-group mineral (e.g., kaolinite, dickite, or halloysite), montmorillonite, bentonite, or acid bentonite in a broad sense, and includes kaolin, fire clay, or the like. Specifically, kaolin (or white clay) which is rich in kaolinite (Al₂O₃·2SiO₂·2H₂O) from among the above-mentioned clay minerals may be used. In the current embodiment, the clay containing 70% or more of kaolinite is used. The clay may contain about 30% to about 99% of kaolinite.

In the current embodiment, the liquid adhesive uses starch paste obtained by mixing starch powder and water. The starch paste may employ, for example, commonly available commercial starch paste for wallpaper. In general, the starch paste may be obtained by mixing 100 wt % of starch powder with about 40 wt % to about 80 wt % of water.

When the content of the liquid adhesive is less than 4 wt %, the silica sand and the clay may not be properly bound together at room temperature and thus sufficient hardness may not be maintained. Meanwhile, when the content of the liquid adhesive is greater than 9 wt %, the mixture of the silica sand and the clay may flow down due to excessively low viscosity at room temperature and thus the agglomerates may not be maintained in shape.

The silica sand serves as a raw material for silicon metal. In general, the silica sand may employ desert sand. Particles of the silica sand may have various sizes depending on how much the silica sand has been weathered. The current embodiment defines that the particles of the silica sand have a size of 0.03 mm to 0.7 mm. The contents of the added clay and the liquid adhesive vary depending on the size of the silica sand particles. Therefore, 0.03 mm to 0.7 mm defined as the size of the particles of the silica sand in the current embodiment is determined based on the contents of the mixed clay and the liquid adhesive.

### Embodiment 2

According to Embodiment 2 of the present invention, silica sand agglomerates for silicon metal production include 7 wt % to 9 wt % of clay, 6 wt % to 12 wt % of a liquid adhesive, and the remaining content of silica sand having a particle size of 0.6 mm to 1.1 mm.

The clay is mixed to maintain binding between the silica sand particles in a reduction process of the agglomerates inserted into a carbothermal reduction furnace. The weight of the mixed clay varies depending on the size of the silica sand particles. The clay may employ, for example, kaolin or loess used to manufacture ceramics. In the current embodiment, when the content of the clay is less than 7 wt %, the agglomerates may be broken into powder at an early stage due to excessively low binding force between the silica sand particles during reduction of the agglomerates in the carbothermal reduction furnace and thus silicon metal may not be properly obtained due to poor heat transfer around the silica sand particles and poor circulation of a reduction gas. When the content of the clay is greater than 9 wt %, although the agglomerates are maintained in sufficient strength during reduction in the carbothermal reduction furnace, the amount of silicon metal in the agglomerates may be reduced due to an excessively large amount of the clay and thus only a small amount of silicon metal may be produced. In the current embodiment, the liquid adhesive uses starch paste obtained by mixing starch powder and water. A detailed description of the clay is provided above in relation to Embodiment 1.

The starch paste may employ, for example, commonly available commercial starch paste for wallpaper. In general, the starch paste may be obtained by mixing 100 wt % of starch powder with about 40 wt % to about 80 wt % of water.

When the content of the liquid adhesive is less than 6 wt %, the silica sand and the clay may not be properly bound together at room temperature and thus sufficient hardness may not be maintained. Meanwhile, when the content of the liquid adhesive is greater than 12 wt %, the mixture of the silica sand and the clay may flow down due to excessively low viscosity at room temperature and thus the agglomerates may not be maintained in shape.

The silica sand serves as a raw material for silicon metal. In general, the silica sand may employ desert sand. Particles of the silica sand may have various sizes depending on how much the silica sand has been weathered. The current embodiment defines that the particles of the silica sand have a size of 0.6 mm to 1.1 mm. The contents of the added clay and the liquid adhesive vary depending on the size of the silica sand particles. Therefore, 0.6 mm to 1.1 mm defined as the size of the particles of the silica sand in the current embodiment is determined based on the contents of the mixed clay and the liquid adhesive.

### Embodiment 3

According to Embodiment 3 of the present invention, silica sand agglomerates for silicon metal production include 12 wt % to 18 wt % of clay, 9 wt % to 15 wt % of a liquid adhesive, and the remaining content of silica sand having a particle size of 0.8 mm to 2.3 mm.

The clay is mixed to maintain binding between the silica sand particles in a reduction process of the agglomerates inserted into a carbothermal reduction furnace. The weight of the mixed clay varies depending on the size of the silica sand particles. The clay may employ, for example, kaolin or loess used to manufacture ceramics. In the current embodiment, when the content of the clay is less than 12 wt %, the agglomerates may be broken into powder at an early stage due to excessively low binding force between the silica sand particles during reduction of the agglomerates in the carbothermal reduction furnace and thus silicon metal may not be properly obtained due to poor heat transfer around the silica sand particles and poor circulation of a reduction gas. When the content of the clay is greater than 18 wt %, although the agglomerates are maintained in sufficient strength during reduction in the carbothermal reduction furnace, the amount of silicon metal in the agglomerates may be reduced due to an excessively large amount of the clay and thus only a small amount of silicon metal may be produced. A detailed description of the clay is provided above in relation to Embodiment 1.

In the current embodiment, the liquid adhesive uses starch paste obtained by mixing starch powder and water. The starch paste may employ, for example, commonly available commercial starch paste for wallpaper. In general, the starch paste may be obtained by mixing 100 wt % of starch powder with about 40 wt % to about 80 wt % of water.

When the content of the liquid adhesive is less than 9 wt %, the silica sand and the clay may not be properly bound together at room temperature and thus sufficient hardness may not be maintained. Meanwhile, when the content of the liquid adhesive is greater than 15 wt %, the mixture of the silica sand and the clay may flow down due to excessively low viscosity at room temperature and thus the agglomerates may not be maintained in shape.

The silica sand serves as a raw material for silicon metal. In general, the silica sand may employ desert sand. Particles of the silica sand may have various sizes depending on how much the silica sand has been weathered. The current embodiment defines that the particles of the silica sand have a size of 0.8 mm to 2.3 mm. The contents of the added clay and the liquid adhesive vary depending on the size of the silica sand particles. Therefore, 0.8 mm to 2.3 mm defined as the size of the particles of the silica sand in the current embodiment is determined based on the contents of the mixed clay and the liquid adhesive.

A method of forming silica sand agglomerates for silicon metal production by using the above-described components will now be described.

The method of forming silica sand agglomerates for silicon metal production, according to the present invention, includes a mixing step S1, a pressing step S2, a forming step S3, and a drying step S4.

In the mixing step S1, clay, a liquid adhesive, and silica sand are mixed at a ratio of the above-mentioned contents. In the mixing step S1, the components may be mixed using an agitator. In the mixing step S1, the components may be mixed at room temperature. In the mixing step S1, an agitation time may be about 3 minutes to about 10 minutes.

In the pressing step S2, the mixture obtained in the mixing step S1 is pressed to reduce pores. In the pressing step S2, the mixture is inserted into a cylindrical mold and pressure is applied using a press such as a piston to reduce the pores in the mixture. In general, it is practically impossible to completely remove the pores in the pressing step S2. In the forming step S3, the mixture pressed in the pressing step S2 is formed into certain-sized agglomerates. The agglomerates formed in the forming step S3 may be have, for example, a spherical, cylindrical, oval briquette, or pebble shape.

In the drying step S4, the agglomerates formed in the forming step S3 are dried. The drying step S4 may employ various drying methods such as heat drying, blow drying, and natural drying. The agglomerates dried in the drying step S4 have an apparent density of 85% to 95%. The apparent density is a percentage calculated by using a surface area of the agglomerate as a denominator and a rate of pores on the surface of the agglomerate as a numerator. When the apparent density of the agglomerates is less than 85% and when the agglomerates are heated to high temperature in a carbothermal reduction furnace, the pores may expand to break the agglomerates. When the apparent density of the agglomerates is greater than 98%, although the agglomerates do not have any significant problem, the pressure applied in the pressing step S2 may be excessively increased and thus the press device may be damaged or a risk of an accident may exist. When the drying step S4 employs natural drying and when the agglomerates have a diameter of about 5 cm to about 8 cm, a drying time may be about 24 hours to about 48 hours. When the drying step S4 employs heat drying or the like, a drying time may be shortened compared to natural drying.

Based on the silica sand agglomerates formed using the above-described components and the above-described method, because silica sand, e.g., desert sand, which is easily available on earth may be used instead of silica stone to produce silicon metal, a raw material may be ensured at a low cost and the natural environment may be protected. Test results show that the silica sand agglomerates are maintained in shape at 1300° C. which is higher than a reduction temperature in a carbothermal reduction furnace, and thus may be a good substitute for silica stone.

As described above, based on silica sand agglomerates for silicon metal production and a method of forming the agglomerates, according to the present invention, because silica sand which is easily available on earth may be used instead of silica stone to produce silicon metal, a raw material may be ensured at a low cost and the natural environment may be protected.

Based on silica sand agglomerates for silicon metal production and a method of forming the agglomerates, according to the present invention, because silica sand which is easily available on earth may be used instead of silica stone to produce silicon metal, a raw material may be ensured at a low cost and the natural environment may be protected.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. Silica sand agglomerates for silicon metal production, the silica sand agglomerates comprising 3 wt % to 6 wt % of clay, 4 wt % to 9 wt % of a liquid adhesive, and a remaining content of silica sand having a particle size of 0.03 mm to 0.7 mm.

2. Silica sand agglomerates for silicon metal production, the silica sand agglomerates comprising 7 wt % to 9 wt % of clay, 6 wt % to 12 wt % of a liquid adhesive, and a remaining content of silica sand having a particle size of 0.6 mm to 1.1 mm.

3. Silica sand agglomerates for silicon metal production, the silica sand agglomerates comprising 12 wt % to 18 wt % of clay, 9 wt % to 15 wt % of a liquid adhesive, and a remaining content of silica sand having a particle size of 0.8 mm to 2.3 mm.

4. The silica sand agglomerates according to claim 1, wherein the liquid adhesive is obtained by mixing starch powder and water.

5. The silica sand agglomerates according to claim 2, wherein the liquid adhesive is obtained by mixing starch powder and water.

6. The silica sand agglomerates according to claim 3, wherein the liquid adhesive is obtained by mixing starch powder and water.

7. A method of forming the silica sand agglomerates according to claim 1, the method comprising:
a mixing step for mixing the clay, the liquid adhesive, and the silica sand;
a pressing step for pressing the mixture obtained in the mixing step, to reduce pores and increase a density;
a forming step for forming the mixture pressed in the pressing step, into certain-sized agglomerates; and
a drying step for drying the agglomerates formed in the forming step.

8. A method of forming the silica sand agglomerates according to claim 2, the method comprising:
a mixing step for mixing the clay, the liquid adhesive, and the silica sand;
a pressing step for pressing the mixture obtained in the mixing step, to reduce pores and increase a density;
a forming step for forming the mixture pressed in the pressing step, into certain-sized agglomerates; and
a drying step for drying the agglomerates formed in the forming step.

9. A method of forming the silica sand agglomerates according to claim 3, the method comprising:
a mixing step for mixing the clay, the liquid adhesive, and the silica sand;
a pressing step for pressing the mixture obtained in the mixing step, to reduce pores and increase a density;
a forming step for forming the mixture pressed in the pressing step, into certain-sized agglomerates; and
a drying step for drying the agglomerates formed in the forming step.

10. The method of claim 7, wherein the agglomerates formed in the forming step have a spherical, cylindrical, oval briquette, or pebble shape.

11. The method of claim 8, wherein the agglomerates formed in the forming step have a spherical, cylindrical, oval briquette, or pebble shape.

12. The method of claim 9, wherein the agglomerates formed in the forming step have a spherical, cylindrical, oval briquette, or pebble shape.

13. The method of claim 7, wherein the drying step employs heat drying, blow drying, or natural drying.

14. The method of claim 8, wherein the drying step employs heat drying, blow drying, or natural drying.

15. The method of claim 9, wherein the drying step employs heat drying, blow drying, or natural drying.
